(19) United States
(12) Patent Application Publication
(10) Pub. No.: US 2026/0054738 A1
(43) Pub. Date: Feb. 26, 2026

(54) INFORMATION PROCESSING APPARATUS, INFORMATION PROCESSING METHOD, AND VEHICLE CONTROL SYSTEM

(71) Applicant: SONY SEMICONDUCTOR SOLUTIONS CORPORATION, KANAGAWA (JP)

(72) Inventors: MOTOHIRO SUZUKI, KANAGAWA (JP); KEIJI NISHIDA, KANAGAWA (JP)

(21) Appl. No.: 19/105,583

(22) PCT Filed: Aug. 2, 2023
(86) PCT No.: PCT/JP2023/028210

§ 371 Date: Feb. 21, 2025

(30) Foreign Application Priority Data
Aug. 30, 2022 (JP) 2022-137090

(51) Int. Cl. B60W 50/00; B60W 30/18; B60W 40/08

(52) U.S. Cl. CPC B60W 50/0098; B60W 30/18159; B60W 40/08; B60W 2040/089; B60W 2520/10; B60W 2530/10; B60W 2540/21; B60W 2540/225; B60W 2552/05; B60W 2552/30; B60W 2554/406; B60W 2555/20; B60W 2556/10

(57) ABSTRACT

An information processing apparatus according to the present disclosure includes: a line-of-sight acquisition unit that acquires line-of-sight information of a driver from a line-of-sight detection unit that detects a line of sight of the driver; a voice acquisition unit that acquires voice information of the driver from a sound collection unit; an operation reception unit; and a risk level calculation unit. The operation reception unit receives an operation instruction uttered by the driver when a predetermined wake word is included in a voice of the driver. The risk level calculation unit calculates a risk level of a vehicle driven by the driver and the surroundings of the vehicle. The operation reception unit has a wake word omission function of receiving the operation instruction uttered by the driver even if the wake word is not included in the voice of the driver while the driver continuously views a predetermined range in the vehicle, and disables the wake word omission function when the risk level calculated by the risk level calculation unit is equal to or higher than a predetermined threshold.

### FIELD

The present disclosure relates to an information processing apparatus, an information processing method, and a vehicle control system.

### BACKGROUND

In recent years, a technology for controlling an operation of an electronic device according to an operation by voice of a user has been used. In this technology, for example, the user can notify the electronic device that the voice operation is to be performed from then by uttering a predetermined keyword (hereinafter, also referred to as a wake word) immediately before the voice operation.

In addition, in the conventional technology, in order to easily operate the electronic device by voice, the user can operate the electronic device by voice by continuously viewing the electronic device for a predetermined time without uttering the wake word (see, for example, Patent Literature 1).

### CITATION LIST

### Patent Literature

Patent Literature 1: JP 2015-514254 A

### SUMMARY

### Technical Problem

The present disclosure proposes an information processing apparatus, an information processing method, and a vehicle control system that can improve safety during driving.

### Solution to Problem

According to the present disclosure, there is provided an information processing apparatus. The information processing apparatus includes the line-of-sight acquisition unit, the voice acquisition unit, the operation reception unit, and the risk level calculation unit. The line-of-sight acquisition unit acquires line-of-sight information of the driver from a line-of-sight detection unit that detects a line of sight of the driver. The voice acquisition unit acquires voice information of the driver from the sound collection unit. The operation reception unit receives an operation instruction uttered by the driver when a predetermined wake word is included in a voice of the driver. The risk level calculation unit calculates a risk level of the vehicle driven by the driver and the surroundings of the vehicle. In addition, the operation reception unit has a wake word omission function of receiving the operation instruction uttered by the driver even if the driver does not include the wake word in the voice of the driver while the driver continuously views a predetermined range in the vehicle. In addition, the operation reception unit disables the wake word omission function in a case where the risk level calculated by the risk level calculation unit is equal to or higher than a predetermined threshold.

### BRIEF DESCRIPTION OF DRAWINGS

FIG. 1 is a block diagram illustrating a configuration example of a vehicle control system according to an embodiment of the present disclosure.

FIG. 2 is a view illustrating an example of a sensing region according to the embodiment of the present disclosure.

FIG. 3 is a block diagram illustrating a detailed configuration example of the vehicle control system according to the embodiment of the present disclosure.

FIG. 4 is a view for describing an example of processing executed by the vehicle control system according to the embodiment of the present disclosure.

FIG. 5 is a view for describing an example of processing executed by the vehicle control system according to the embodiment of the present disclosure.

FIG. 6 is a view for describing an example of processing executed by the vehicle control system according to the embodiment of the present disclosure.

FIG. 7 is a view for describing an example of processing executed by the vehicle control system according to the embodiment of the present disclosure.

FIG. 8 is a view for describing an example of processing executed by a vehicle control system according to a modification of the embodiment of the present disclosure.

FIG. 9 is a view for describing an example of processing executed by the vehicle control system according to the modification of the embodiment of the present disclosure.

FIG. 10 is a flowchart illustrating an example of procedure of control processing executed by the vehicle control system according to the embodiment of the present disclosure.

FIG. 11 is a flowchart illustrating an example of procedure of control processing executed by the vehicle control system according to the modification of the embodiment of the present disclosure.

### DESCRIPTION OF EMBODIMENTS

Hereinafter, embodiments of the present disclosure will be described with reference to the accompanying drawings. Note that the present disclosure is not limited to the following embodiments. In addition, the respective embodiments can be appropriately combined within a range that does not contradict processing contents. In addition, the same portions are denoted by the same reference signs in each of the following embodiments, and a repetitive description thereof will be omitted.

In recent years, a technology for controlling an operation of an electronic device according to an operation by voice of a user has been used. In this technology, for example, the user can notify the electronic device that the voice operation is to be performed from then by uttering a predetermined keyword (hereinafter, also referred to as a wake word) immediately before the voice operation.

In addition, in the conventional technology, in order to easily operate the electronic device by voice, the user can operate the electronic device by voice by continuously viewing the electronic device for a predetermined time without uttering the wake word. As a result, the electronic device can be easily operated by voice.

However, in the above-described conventional technology, there is a case where a driver continuously gazes at an on-vehicle device, such as a navigation device, in order to omit the wake word when operating the on-vehicle device by voice so that attention to the front is not sufficient. In particular, in a case where a risk level of a vehicle or a risk level of the surroundings of the vehicle is high, there is a possibility that safety during driving is impaired if the driver pays insufficient attention to the front.

Therefore, it is expected to achieve a technology capable of overcoming the above-described problem and improving the safety during driving.

### <Configuration Example of Vehicle Control System>

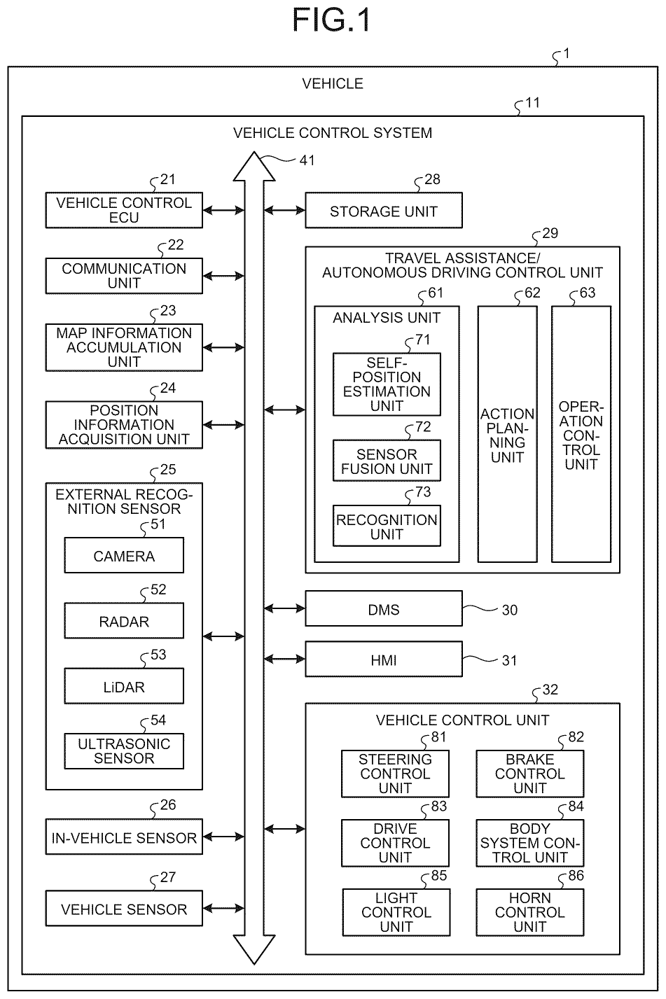

FIG. 1 is a block diagram illustrating a configuration example of a vehicle control system 11 which is an example of a moving device control system to which the present technology is applied.

The vehicle control system 11 is provided in a vehicle 1 and performs processing related to travel assistance and autonomous driving of the vehicle 1.

The vehicle control system 11 includes a vehicle control electronic control unit (ECU) 21, a communication unit 22, a map information accumulation unit 23, a position information acquisition unit 24, an external recognition sensor 25, an in-vehicle sensor 26, a vehicle sensor 27, a storage unit 28, a travel assistance/autonomous driving control unit 29, a driver monitoring system (DMS) 30, a human machine interface (HMI) 31, and a vehicle control unit 32. The travel assistance/autonomous driving control unit 29 is an example of an information processing apparatus and a control unit.

The vehicle control ECU 21, the communication unit 22, the map information accumulation unit 23, the position information acquisition unit 24, the external recognition sensor 25, the in-vehicle sensor 26, the vehicle sensor 27, the storage unit 28, the travel assistance/autonomous driving control unit 29, the driver monitoring system (DMS) 30, the human machine interface (HMI) 31, and the vehicle control unit 32 are connected to be capable of communicating with each other via a communication network 41. The communication network 41 includes, for example, an on-vehicle communication network, a bus, and the like conforming to digital bidirectional communication standards such as a controller area network (CAN), a local interconnect network (LIN), a local area network (LAN), FlexRay (registered trademark), and Ethernet (registered trademark). The communication network 41 may be selectively used depending on a type of data to be transmitted. For example, the CAN may be applied to data related to vehicle control, and the Ethernet may be applied to large-capacity data. Note that each unit of the vehicle control system 11 may be directly connected using wireless communication that assumes communication at a relatively short range, such as near field communication (NFC) or Bluetooth (registered trademark), without the intervention of the communication network 41.

Note that the description of the communication network 41 will be omitted hereinafter in a case where each unit of the vehicle control system 11 performs communication via the communication network 41. For example, it is simply described that the vehicle control ECU 21 and the communication unit 22 perform communication in a case where the vehicle control ECU 21 and the communication unit 22 perform communication via the communication network 41.

The vehicle control ECU 21 includes, for example, various processors such as a central processing unit (CPU) and a micro processing unit (MPU). The vehicle control ECU 21 controls all or some functions of the vehicle control system 11.

The communication unit 22 communicates with various devices inside and outside the vehicle, other vehicles, servers, base stations, and the like, and transmits and receives various types of data. At this time, the communication unit 22 can perform communication using a plurality of communication methods.

Communication with the outside of the vehicle that can be executed by the communication unit 22 will be schematically described. The communication unit 22 communicates with a server (hereinafter, referred to as an external server) or the like existing on an external network via a base station or an access point by a wireless communication method such as 5th generation (5G) mobile communication system, long term evolution (LTE), or dedicated short range communications (DSRC). The external network with which the communication unit 22 communicates is, for example, the Internet, a cloud network, a network unique to a business operator, or the like. The communication method by which the communication unit 22 communicates with the external network is not particularly limited as long as it is a wireless communication method capable of performing digital bidirectional communication at a communication speed equal to or higher than a predetermined speed and in a range equal to or longer than a predetermined range.

In addition, for example, the communication unit 22 can communicate with a terminal existing in the vicinity of the own vehicle using a peer to peer (P2P) technology. The terminal present in the vicinity of the own vehicle is, for example, a terminal worn by a mobile object moving at a relatively low speed such as a pedestrian or a bicycle, a terminal installed at a fixed position in a store or the like, or a machine type communication (MTC) terminal. Further, the communication unit 22 can also perform V2X communication. The V2X communication refers to, for example, communication between the own vehicle and the others, such as vehicle to vehicle communication with another vehicle, vehicle to infrastructure communication with a roadside device and the like, vehicle to home communication, and vehicle to pedestrian communication with a terminal or the like carried by a pedestrian.

For example, the communication unit 22 can receive a program for updating software for controlling an operation of the vehicle control system 11 from the outside (Over The Air). The communication unit 22 can further receive map information, traffic information, information around the vehicle 1, and the like from the outside. In addition, for example, the communication unit 22 can transmit information related to the vehicle 1, information around the vehicle 1, and the like to the outside. Examples of the information related to the vehicle 1 transmitted to the outside by the communication unit 22 include data indicating a state of the vehicle 1, a recognition result obtained by a recognition unit 73, and the like. Further, for example, the communication unit 22 performs communication corresponding to a vehicle emergency call system such as an eCall.

For example, the communication unit 22 receives an electromagnetic wave transmitted by a road traffic information communication system (Vehicle Information and Communication System (VICS) (registered trademark) such as a radio wave beacon, an optical beacon, or FM multiplex broadcasting.

Communication with the inside of the vehicle that can be executed by the communication unit 22 will be schematically described. The communication unit 22 can communicate with each device in the vehicle using, for example, wireless communication. The communication unit 22 can perform wireless communication with devices in the vehicle by a communication method capable of performing digital bidirectional communication at a predetermined communication speed or higher by wireless communication, such as wireless LAN, Bluetooth, NFC, or wireless USB (WUSB). The communication unit 22 is not limited thereto, and can also communicate with each device in the vehicle using wired communication. For example, the communication unit 22 can communicate with each device in the vehicle by wired communication via a cable connected to a connection terminal (not illustrated). The communication unit 22 can communicate with each device in the vehicle by a communication method capable of performing digital bidirectional communication at a predetermined communication speed or higher by wired communication, such as universal serial bus (USB), high-definition multimedia interface (HDMI) (registered trademark), or mobile high-definition link (MHL).

Here, the devices in the vehicle refer to, for example, devices that are not connected to the communication network 41 in the vehicle. As the devices in the vehicle, for example, a mobile device or a wearable device carried by a passenger such as a driver, an information device brought and temporarily installed inside the vehicle, and the like are assumed.

The map information accumulation unit 23 accumulates one or both of a map acquired from the outside and a map created by the vehicle 1. For example, the map information accumulation unit 23 accumulates a three-dimensional high-precision map, a global map that is less precise than the high-precision map and covers a wide area, and the like.

The high-precision map is, for example, a dynamic map, a point cloud map, a vector map, or the like. The dynamic map is, for example, a map including four layers of dynamic information, semi-dynamic information, semi-static information, and static information, and is provided to the vehicle 1 from an external server or the like. The point cloud map is a map including a point cloud (point cloud data). The vector map is, for example, a map in which traffic information such as a lane and a position of a traffic light is associated with the point cloud map and adapted to an advanced driver assistance system (ADAS) or autonomous driving (AD).

The point cloud map and the vector map may be provided from, for example, an external server or the like, or may be created by the vehicle 1 as a map for performing matching with a local map to be described later based on a sensing result, obtained by a camera 51, a radar 52, a LiDAR 53, or the like, and accumulated in the map information accumulation unit 23. In addition, in a case where the high-precision map is provided from the external server or the like, for example, map data of several hundred meters square related to a planned global path on which the vehicle 1 is to travel from then is acquired from the external server or the like in order to reduce a volume of communication.

The position information acquisition unit 24 receives a global navigation satellite system (GNSS) signal from a GNSS satellite, and acquires position information of the vehicle 1. The acquired position information is supplied to the travel assistance/autonomous driving control unit 29. Note that the position information acquisition unit 24 may acquire the position information using, for example, a beacon without being limited to the method using the GNSS signal.

The external recognition sensor 25 includes various sensors used to recognize a situation outside the vehicle 1, and supplies sensor data from each sensor to each unit of the vehicle control system 11. Types and the number of sensors included in the external recognition sensor 25 are freely set.

For example, the external recognition sensor 25 includes the camera 51, the radar 52, the LiDAR (light detection and ranging or laser imaging detection and ranging) 53, and an ultrasonic sensor 54. The external recognition sensor 25 is not limited thereto, and may include one or more types of sensors of the camera 51, the radar 52, the LiDAR 53, and the ultrasonic sensor 54. The number of the cameras 51, the number of the radars 52, the number of the LiDAR 53, and the number of the ultrasonic sensors 54 are not particularly limited as long as installation of the number in the vehicle 1 is practically possible. In addition, the types of sensors included in the external recognition sensor 25 are not limited to this example, and the external recognition sensor 25 may include another type of sensor. An example of a sensing region of each sensor included in the external recognition sensor 25 will be described later.

Note that an image capturing method of the camera 51 is not particularly limited. For example, cameras adopting various image capturing methods such as a time-of-flight (ToF) camera, a stereo camera, a monocular camera, and an infrared camera, which are image capturing methods capable of distance measurement, can be applied to the camera 51 as necessary. The camera 51 is not limited thereto and may simply acquire a captured image regardless of distance measurement.

In addition, for example, the external recognition sensor 25 can include an environment sensor for detecting an environment of the vehicle 1. The environment sensor is a sensor for detecting an environment such as weather, climate, and brightness, and can include various sensors such as a raindrop sensor, a fog sensor, a sunshine sensor, a snow sensor, and an illuminance sensor.

Further, for example, the external recognition sensor 25 includes a microphone used to detect a sound around the vehicle 1, a position of a sound source, and the like.

The in-vehicle sensor 26 includes various sensors for detecting information inside the vehicle, and supplies sensor data from each sensor to each unit of the vehicle control system 11. Types and the number of the various sensors included in the in-vehicle sensor 26 are not particularly limited as long as installation of the types and the number in the vehicle 1 is practically possible.

For example, the in-vehicle sensor 26 can include one or more sensors of a camera, a radar, a seating sensor, a steering wheel sensor, a microphone, and a biometric sensor. As the camera included in the in-vehicle sensor 26, for example, cameras of various image capturing methods capable of measuring a distance, such as a ToF camera, a stereo camera, a monocular camera, and an infrared camera, can be used. The camera included in the in-vehicle sensor 26 is not limited thereto, and may be one simply acquiring a captured image regardless of distance measurement. The biometric sensor included in the in-vehicle sensor 26 is provided, for example, on a seat, a steering wheel, or the like, and detects various types of biometric information of a passenger such as a driver. Details of the in-vehicle sensor 26 will be described later.

The vehicle sensor 27 includes various sensors for detecting the state of the vehicle 1, and supplies sensor data from each sensor to each unit of the vehicle control system 11. Types and the number of the various sensors included in the vehicle sensor 27 are not particularly limited as long as installation of the types and the number in the vehicle 1 is practically possible.

For example, the vehicle sensor 27 includes a speed sensor, an acceleration sensor, an angular velocity sensor (gyro sensor), and an inertial measurement unit (IMU) integrating these sensors. For example, the vehicle sensor 27 includes a steering angle sensor that detects a steering angle of a steering wheel, a yaw rate sensor, an accelerator sensor that detects an operation amount of an accelerator pedal, and a brake sensor that detects an operation amount of a brake pedal. For example, the vehicle sensor 27 includes a rotation sensor that detects a rotational speed of an engine or a motor, an air pressure sensor that detects an air pressure of a tire, a slip rate sensor that detects a slip rate of a tire, and a wheel speed sensor that detects the rotation speed of wheels. For example, the vehicle sensor 27 includes a battery sensor that detects a remaining capacity and a temperature of a battery, and an impact sensor that detects an external impact.

The storage unit 28 includes at least one of a nonvolatile storage medium and a volatile storage medium, and stores data and a program. The storage unit 28 is used as, for example, an electrically erasable programmable read only memory (EEPROM) and a random access memory (RAM), and a magnetic storage device such as a hard disc drive (HDD), a semiconductor storage device, an optical storage device, and a magneto-optical storage device can be applied as the storage medium. The storage unit 28 stores various programs and data to be used by each unit of the vehicle control system 11. For example, the storage unit 28 includes an event data recorder (EDR) and a data storage system for automated driving (DSSAD), and stores information of the vehicle 1 before and after an event such as an accident and information acquired by the in-vehicle sensor 26.

The travel assistance/autonomous driving control unit 29 controls travel assistance and autonomous driving of the vehicle 1. For example, the travel assistance/autonomous driving control unit 29 includes an analysis unit 61, an action planning unit 62, and an operation control unit 63.

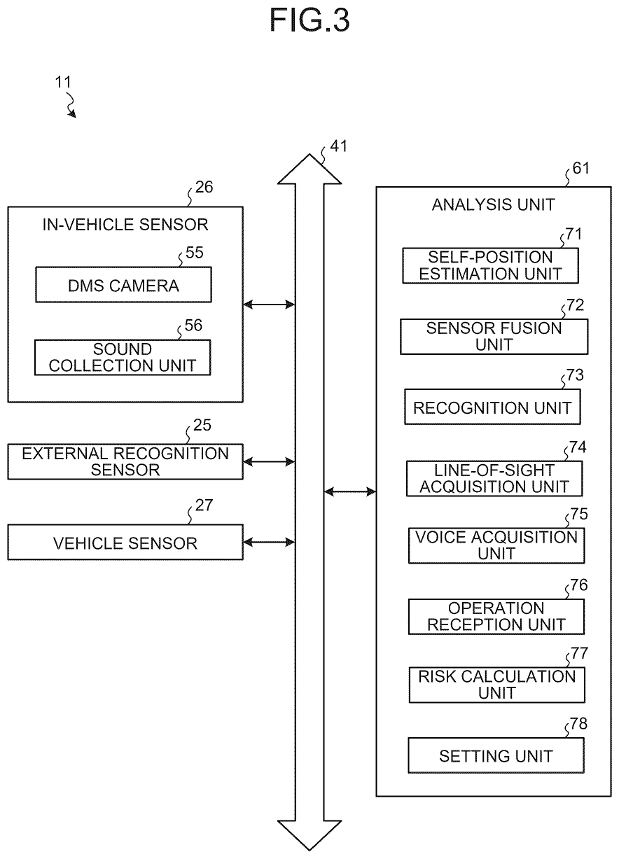

The analysis unit 61 performs processing of analyzing situations of the vehicle 1 and the surroundings thereof. The analysis unit 61 includes a self-position estimation unit 71, a sensor fusion unit 72, and the recognition unit 73. In addition, the analysis unit 61 according to the embodiment further includes a line-of-sight acquisition unit 74 (see FIG. 3), a voice acquisition unit 75 (see FIG. 3), an operation reception unit 76 (see FIG. 3), a risk level calculation unit 77 (see FIG. 3), and a setting unit 78 (see FIG. 3).

The self-position estimation unit 71 estimates a self-position of the vehicle 1 based on the sensor data from the external recognition sensor 25 and the high-precision map accumulated in the map information accumulation unit 23. For example, the self-position estimation unit 71 generates a local map based on the sensor data from the external recognition sensor 25, and estimates the self-position of the vehicle 1 by matching the local map with the high-precision map. The position of the vehicle 1 is based on, for example, the center of a rear wheel pair axle.

The local map is, for example, a three-dimensional high-precision map created using a technology such as simultaneous localization and mapping (SLAM), an occupancy grid map, or the like. The three-dimensional high-precision map is, for example, the above-described point cloud map or the like. The occupancy grid map is a map in which a three-dimensional or two-dimensional space around the vehicle 1 is divided into grids each having a predetermined size, and an occupancy state of an object is indicated in units of grids. The occupancy state of the object is indicated by, for example, the presence or absence or existence probability of the object. The local map is also used for detection processing and recognition processing of a situation outside the vehicle 1 by the recognition unit 73, for example.

Note that the self-position estimation unit 71 may estimate the self-position of the vehicle 1 based on the position information acquired by the position information acquisition unit 24 and the sensor data from the vehicle sensor 27.

The sensor fusion unit 72 performs sensor fusion processing of combining a plurality of different types of sensor data (for example, image data supplied from the camera 51 and sensor data supplied from the radar 52) to obtain new information. Methods for combining different types of sensor data include integration, fusion, association, and the like.

The recognition unit 73 executes the detection processing for detecting the situation outside the vehicle 1 and the recognition processing for recognizing the situation outside the vehicle 1.

For example, the recognition unit 73 performs the detection processing and the recognition processing of the situation outside the vehicle 1 based on information from the external recognition sensor 25, information from the self-position estimation unit 71, information from the sensor fusion unit 72, and the like.

Specifically, for example, the recognition unit 73 performs detection processing, recognition processing, and the like of an object around the vehicle 1. The detection processing of the object is, for example, processing of detecting the presence or absence, a size, a shape, a position, a movement, and the like of the object. The recognition processing of the object is, for example, processing of recognizing an attribute such as a type of the object or identifying a specific object. However, the detection processing and the recognition processing are not necessarily clearly divided, and may overlap.

For example, the recognition unit 73 detects the object around the vehicle 1 by performing clustering to classify point clouds based on sensor data by the radar 52, the LiDAR 53, or the like into clusters of the point clouds. As a result, the presence or absence, size, shape, and position of the object around the vehicle 1 are detected.

For example, the recognition unit 73 detects the movement of the object around the vehicle 1 by performing tracking that follows the movement of a cluster of point clouds classified by clustering. As a result, a speed and a traveling direction (movement vector) of the object around the vehicle 1 are detected.

For example, the recognition unit 73 detects or recognizes a vehicle, a person, a bicycle, an obstacle, a structure, a road, a traffic light, a traffic sign, a road sign, and the like based on the image data supplied from the camera 51. In addition, the recognition unit 73 may recognize a type of the object around the vehicle 1 by performing recognition processing such as semantic segmentation.

For example, the recognition unit 73 can perform recognition processing of a traffic rule around the vehicle 1 based on the map accumulated in the map information accumulation unit 23, the estimation result of the self-position by the self-position estimation unit 71, and the recognition result of the object around the vehicle 1 by the recognition unit 73. Through this processing, the recognition unit 73 can recognize a position and a state of the traffic light, the content of the traffic sign and the road sign, the content of the traffic regulation, the travelable lane, and the like.

For example, the recognition unit 73 can perform recognition processing of a surrounding environment of the vehicle 1. As the surrounding environment to be recognized by the recognition unit 73, weather, temperature, humidity, brightness, a state of a road surface, and the like are assumed.

Details of the analysis unit 61 according to the embodiment including the line-of-sight acquisition unit 74, the voice acquisition unit 75, the operation reception unit 76, the risk level calculation unit 77, and the setting unit 78 not illustrated in FIG. 1 will be described later.

The action planning unit 62 creates an action plan of the vehicle 1. For example, the action planning unit 62 performs processing of global path planning and global path following, thereby creating an action plan.

Note that the global path planning is processing of planning a rough global path from a start to a goal. This global path planning is called local path planning, and also includes processing of performing local path planning that enables safe and smooth traveling in the vicinity of the vehicle 1 in consideration of motion characteristics of the vehicle 1 in the planned global path.

The global path following is processing of planning an operation for safe and accurate traveling along the global path planned by the global path planning within a planned time. For example, the action planning unit 62 can calculate a target speed and a target angular velocity of the vehicle 1 based on a result of this global path following processing.

The operation control unit 63 controls the operation of the vehicle 1 in order to implement the action plan created by the action planning unit 62.

For example, the operation control unit 63 controls a steering control unit 81, a brake control unit 82, and a drive control unit 83 included in the vehicle control unit 32 to be described later, and performs acceleration/deceleration control and direction control such that the vehicle 1 travels along a local path calculated by the local path planning. For example, the operation control unit 63 performs cooperative control for the purpose of implementing functions of the ADAS such as collision avoidance or impact mitigation, follow-up traveling, vehicle speed maintaining traveling, collision warning of the own vehicle, lane deviation warning of the own vehicle, and the like. For example, the operation control unit 63 performs cooperative control for the purpose of autonomous driving or the like for autonomous traveling without depending on an operation of the driver.

The DMS 30 performs authentication processing for the driver, recognition processing for a state of the driver, and the like based on sensor data supplied from the in-vehicle sensor 26, input data input to the HMI 31 to be described later, and the like. As the state of the driver to be recognized, for example, a physical condition, a wakefulness level, a concentration level, a fatigue level, a line-of-sight direction, a drunkenness level, a driving operation, a posture, and the like are assumed.

Note that the DMS 30 may perform authentication processing for a passenger other than the driver and recognition processing for a state of the passenger. In addition, for example, the DMS 30 may perform recognition processing for a situation inside the vehicle based on sensor data from the in-vehicle sensor 26. As the situation inside the vehicle to be recognized, for example, temperature, humidity, brightness, odor, and the like are assumed.

The HMI 31 inputs various types of data, instructions, and the like, and presents various types of data to the driver and the like.

Data input by the HMI 31 will be schematically described. The HMI 31 includes an input device that allows a person to input data. The HMI 31 generates an input signal based on data, an instruction, or the like input by the input device, and supplies the input signal to each unit of the vehicle control system 11. The HMI 31 includes an operating element such as a touch panel, a button, a switch, and a lever as the input device. The HMI 31 is not limited thereto, and may further include an input device capable of inputting information by a method other than a manual operation by voice, a gesture, or the like. Further, the HMI 31 may use, for example, a remote control device that uses infrared rays or radio waves, or an external connection device such as a mobile device or a wearable device corresponding to an operation of the vehicle control system 11 as the input device.

Presentation of data by the HMI 31 will be schematically described. The HMI 31 generates visual information, auditory information, and tactile information for a passenger or the outside of the vehicle. In addition, the HMI 31 performs output control for controlling output, output content, an output timing, an output method, and the like of each piece of the generated information. The HMI 31 generates and outputs, for example, an operation screen, a state display of the vehicle 1, a warning display, an image such as a monitor image indicating the situation around the vehicle 1, and information indicated by light as the visual information. In addition, the HMI 31 generates and outputs information represented by sounds such as voice guidance, a warning sound, and a warning message, for example, as the auditory information. Further, the HMI 31 generates and outputs, as the tactile information, information given to the tactile sense of the passenger by, for example, a force, a vibration, a movement, or the like.

As an output device to which the HMI 31 outputs the visual information, for example, a display apparatus that displays an image by itself to present the visual information or a projector device that projects an image to present the visual information can be applied. Note that the display apparatus may be an apparatus that displays the visual information in a field of view of a passenger, such as a head-up display, a transparent display, or a wearable device having an augmented reality (AR) function, in addition to a display apparatus having a normal display. In addition, the HMI 31 can use a display device included in a navigation device, an instrument panel, a camera monitoring system (CMS), an electronic mirror, a lamp, or the like provided in the vehicle 1 as the output device to which the visual information is output.

As an output device to which the HMI 31 outputs the auditory information, for example, an audio speaker, a headphone, or an earphone can be applied.

As an output device to which the HMI 31 outputs the tactile information, for example, a haptic element using a haptic technology can be applied. The haptic element is provided, for example, in a portion with which a passenger of the vehicle 1 comes into contact, such as a steering wheel or a seat.

The vehicle control unit 32 controls each unit of the vehicle 1. The vehicle control unit 32 includes the steering control unit 81, the brake control unit 82, the drive control unit 83, a body system control unit 84, a light control unit 85, and a horn control unit 86.

The steering control unit 81 detects and controls a state of a steering system of the vehicle 1. The steering system includes, for example, a steering mechanism including a steering wheel and the like, an electric power steering, and the like. The steering control unit 81 includes, for example, a steering ECU that controls the steering system, an actuator that drives the steering system, and the like.

The brake control unit 82 detects and controls a state of a brake system of the vehicle 1. The brake system includes, for example, a brake mechanism including a brake pedal, an antilock brake system (ABS), a regenerative brake mechanism, and the like. The brake control unit 82 includes, for example, a brake ECU that controls the brake system, an actuator that drives the brake system, and the like.

The drive control unit 83 detects and controls a state of a drive system of the vehicle 1. The drive system includes, for example, a driving force generation device for generating a driving force such as an accelerator pedal, an internal combustion engine, or a driving motor, a driving force transmission mechanism for transmitting the driving force to wheels, and the like. The drive control unit 83 includes, for example, a drive ECU that controls the drive system, an actuator that drives the drive system, and the like.

The body system control unit 84 detects and controls a state of a body system of the vehicle 1. The body system includes, for example, a keyless entry system, a smart key system, a power window device, a power seat, an air conditioner, an airbag, a seat belt, a shift lever, and the like. The body system control unit 84 includes, for example, a body system ECU that controls the body system, an actuator that drives the body system, and the like.

The light control unit 85 detects and controls states of various lights of the vehicle 1. As the lights to be controlled, for example, a headlight, a backlight, a fog light, a turn signal, a brake light, a projection, a display of a bumper, and the like are assumed. The light control unit 85 includes a light ECU that controls the lights, an actuator that drives the lights, and the like.

The horn control unit 86 detects and controls a state of a car horn of the vehicle 1. The horn control unit 86 includes, for example, a horn ECU that controls the car horn, an actuator that drives the car horn, and the like.

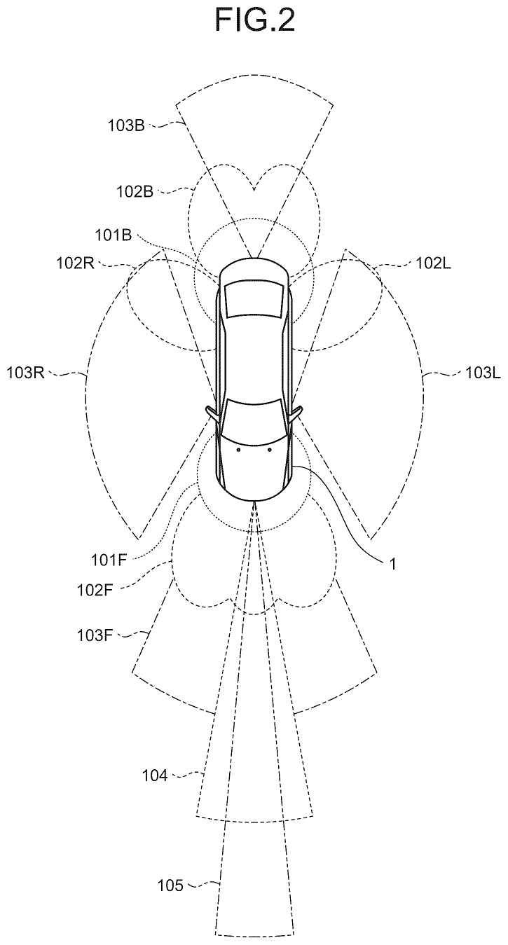

FIG. 2 is a view illustrating an example of sensing regions by the camera 51, the radar 52, the LiDAR 53, the ultrasonic sensor 54, and the like of the external recognition sensor 25 in FIG. 1. Note that FIG. 2 schematically illustrates the vehicle 1 as viewed from above, where a left end side is a front end (front) side of the vehicle 1 and a right end side is a rear end (rear) side of the vehicle 1.

A sensing region 101F and a sensing region 101B illustrate examples of the sensing region of the ultrasonic sensor 54. The sensing region 101F covers the periphery of the front end of the vehicle 1 by a plurality of the ultrasonic sensors 54. The sensing region 101B covers the periphery of the rear end of the vehicle 1 by a plurality of the ultrasonic sensors 54.

Sensing results in the sensing region 101F and the sensing region 101B are used, for example, for parking assistance of the vehicle 1.

Sensing regions 102F to 102B illustrate examples of the sensing region of the radar 52 for a short range or a medium range. The sensing region 102F covers a position farther than the sensing region 101F in front of the vehicle 1. The sensing region 102B covers a position farther than the sensing region 101B at the rear of the vehicle 1. The sensing region 102L covers the rear periphery of a left side surface of the vehicle 1. The sensing region 102R covers the rear periphery of a right side surface of the vehicle 1.

A sensing result in the sensing region 102F is used, for example, for detection of a vehicle, a pedestrian, or the like existing in front of the vehicle 1. A sensing result in the sensing region 102B is used, for example, for a collision prevention function or the like at the rear of the vehicle 1. Sensing results in the sensing region 102L and the sensing region 102R are used, for example, for detection of an object in a blind spot on the side of the vehicle 1.

Sensing regions 103F to 103B illustrate examples of the sensing region by the camera 51. The sensing region 103F covers a position farther than the sensing region 102F in front of the vehicle 1. The sensing region 103B covers a position farther than the sensing region 102B at the rear of the vehicle 1. The sensing region 103L covers the periphery of the left side surface of the vehicle 1. The sensing region 103R covers the periphery of the right side surface of the vehicle 1.

A sensing result in the sensing region 103F can be used for, for example, recognition of a traffic light or a traffic sign, a lane departure prevention assistance system, and an automatic headlight control system. A sensing result in the sensing region 103B can be used for, for example, the parking assistance and a surround view system. Sensing results in the sensing region 103L and the sensing region 103R can be used for the surround view system, for example.

A sensing region 104 illustrates an example of the sensing region of the LiDAR 53. The sensing region 104 covers a position farther than the sensing region 103F in front of the vehicle 1. On the other hand, the sensing region 104 has a narrower range in the left-right direction than the sensing region 103F.

A sensing result in the sensing region 104 is used, for example, for detection of an object such as a nearby vehicle.

A sensing region 105 illustrates an example of the sensing region of the radar 52 for a long range. The sensing region 105 covers a position farther than the sensing region 104 in front of the vehicle 1. On the other hand, the sensing region 105 has a narrower range in the left-right direction than the sensing region 104.

A sensing result in the sensing region 105 is used for, for example, adaptive cruise control (ACC), emergency braking, collision avoidance, and the like.

Note that the sensing regions of the respective sensors of the camera 51, the radar 52, the LiDAR 53, and the ultrasonic sensor 54 included in the external recognition sensor 25 may adopt various configurations other than those in FIG. 2. Specifically, the ultrasonic sensor 54 may also sense the side of the vehicle 1, or the LiDAR 53 may sense the rear of the vehicle 1. In addition, installation positions of the respective sensors are not limited to the examples described above. In addition, the number of the sensors may be one or more.

### <Details of Control Processing>

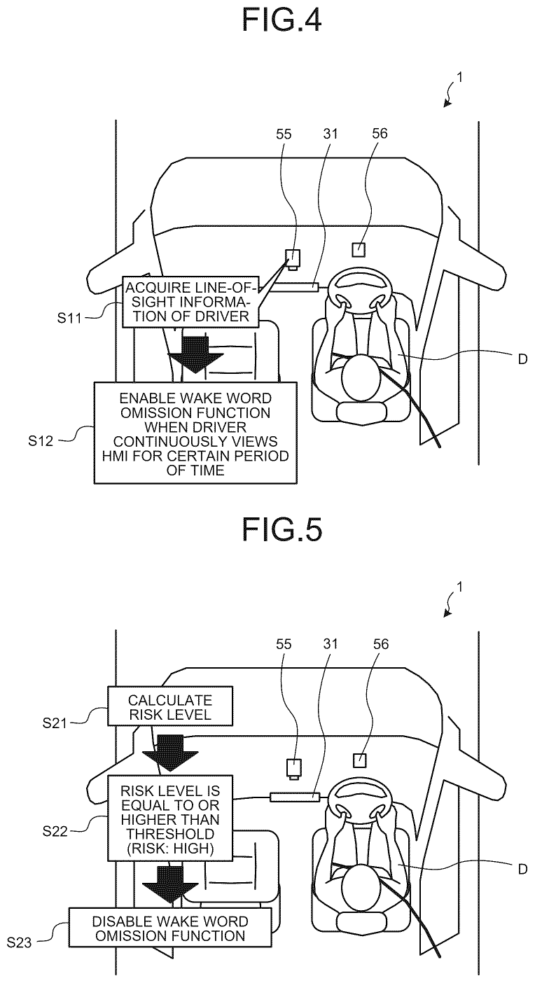

Next, details of control processing according to the embodiment will be described with reference to FIGS. 3 to 9. FIG. 3 is a block diagram illustrating a detailed configuration example of the vehicle control system 11 according to the embodiment of the present disclosure. In addition, FIGS. 4 to 7 are views for describing examples of processing executed by the vehicle control system 11 according to the embodiment of the present disclosure.

As illustrated in FIG. 3, the in-vehicle sensor 26 according to the embodiment includes a DMS camera 55 and a sound collection unit 56. The DMS camera 55 is an example of a line-of-sight detection unit.

The DMS camera 55 captures a state of a driver D (see FIG. 4) sitting on a driver's seat of the vehicle 1. For example, the DMS camera 55 can capture a position of an eyeball of the driver D to acquire information related to a direction of a line of sight of the driver D. The DMS camera 55 is disposed on, for example, an instrument panel of the vehicle 1.

The sound collection unit 56 is, for example, a microphone, and collects a voice of a passenger riding in the vehicle 1. The sound collection unit 56 is disposed, for example, on an instrument panel, a steering wheel, a ceiling, or the like of the vehicle 1.

The analysis unit 61 includes the self-position estimation unit 71, the sensor fusion unit 72, the recognition unit 73, the line-of-sight acquisition unit 74, the voice acquisition unit 75, the operation reception unit 76, the risk level calculation unit 77, and the setting unit 78, and implements or executes functions and actions of the control processing described below.

Note that an internal configuration of the analysis unit 61 is not limited to the configuration illustrated in FIG. 3, and may be another configuration as long as the control processing to be described later is performed with the configuration. In addition, since the self-position estimation unit 71, the sensor fusion unit 72, and the recognition unit 73 have been described above, a detailed description thereof will be omitted.

The line-of-sight acquisition unit 74 acquires line-of-sight information on the line of sight of the driver D from the DMS camera 55. The voice acquisition unit 75 acquires, from the sound collection unit 56, voice information on a voice uttered by the driver D.

In a case where the voice of the driver D acquired by the voice acquisition unit 75 includes an operation instruction on the on-vehicle device (device (for example, a navigation device, an audio device, or the like) connected to the communication network 41 (see FIG. 1)), the operation reception unit 76 receives the operation instruction. That is, the operation reception unit 76 receives a voice operation with respect to the on-vehicle device from the driver D using a known voice recognition technology.

The risk level calculation unit 77 calculates a risk level of the vehicle 1 and the surroundings of the vehicle 1. For example, the risk level calculation unit 77 calculates the risk level of the vehicle 1 and the surroundings of the vehicle 1 based on a situation of the vehicle 1 and a situation around the vehicle 1 obtained from the external recognition sensor 25, the in-vehicle sensor 26, the vehicle sensor 27, and the like.

The setting unit 78 sets a viewing time required to enable a wake word omission function based on the risk level calculated by the risk level calculation unit 77.

First, the wake word omission function included in the operation reception unit 76 according to the embodiment will be described with reference to FIG. 4. First, as illustrated in FIG. 4, the line-of-sight acquisition unit 74 (see FIG. 3) acquires line-of-sight information regarding the line of sight of the driver D (step S11). For example, the line-of-sight acquisition unit 74 acquires information related to the direction of the line of sight of the driver D.

Then, the operation reception unit 76 (see FIG. 3) receives a voice operation from the driver D even if the driver D does not utter a predetermined wake word while continuously viewing a predetermined range (for example, the HMI 31 or the like) for a certain period of time.

That is, the operation reception unit 76 enables the wake word omission function when the driver D continuously views the HMI 31 or the like for the certain period of time (step S12). As a result, the on-vehicle device can be operated by voice even if the wake word is omitted, and thus, the on-vehicle device can be easily operated by voice.

Next, an example of control processing of the vehicle control system 11 according to the embodiment will be described with reference to FIG. 5. First, as illustrated in FIG. 5, the risk level calculation unit 77 (see FIG. 3) calculates a risk level of the vehicle 1 itself and a risk level of the surroundings of the vehicle 1 as numerical values (step S21).

In the embodiment, the risk level calculation unit 77 calculates the risk level such that a value of the risk level increases as a risk of the vehicle 1 itself and a risk of the surroundings of the vehicle 1 increase.

For example, the risk level calculation unit 77 calculates the risk level based on a speed of the vehicle 1. In this case, the risk level calculation unit 77 preferably increases a value of the risk level as the speed of the vehicle 1 increases.

Next, the operation reception unit 76 (see FIG. 3) determines whether or not the risk level calculated in the processing of step S21 is equal to or higher than a predetermined threshold. Then, in a case where the risk level is equal to or higher than the predetermined threshold, that is, in a case where the risk of the vehicle 1 itself and the surroundings of the vehicle 1 is high (step S22), the operation reception unit 76 disables the above-described wake word omission function (step S23).

In this case, the driver D cannot operate the on-vehicle device by voice without uttering the wake word.

As described above, it is possible to prevent the driver D from continuously viewing the HMI 31 to enable the wake word omission function in a case where the speed of the vehicle 1 is high and the risk of the vehicle 1 itself is high in the embodiment. Therefore, the safety during driving can be improved according to the embodiment.

Although an example in which the risk level calculation unit 77 calculates the risk level based on the speed of the vehicle 1 has been described in the above example, the present disclosure is not limited to such an example. For example, in the embodiment, the risk level calculation unit 77 may calculate the risk level based on a weight of the vehicle 1.

In this case, the risk level calculation unit 77 preferably calculates the risk level such that a value of the risk level increases as the weight of the vehicle 1 increases, for example.

As a result, when the weight of the vehicle 1 is heavy and the degree of influence on the surroundings in the event of an accident is great, it is possible to prevent the driver D from continuously viewing the HMI 31 to enable the wake word omission function. Therefore, the safety of the vehicle 1 with respect to the surroundings can be improved according to the embodiment.

In addition, in the embodiment, the risk level calculation unit 77 may calculate the risk level based on an accident history at a spot where the vehicle 1 is traveling. In this case, for example, the risk level calculation unit 77 preferably calculates the risk level such that a value of the risk level increases as the cumulative number of accidents at the spot where the vehicle is traveling increases.

As a result, it is possible to prevent the driver D from continuously viewing the HMI 31 to enable the wake word omission function in a case where a traffic accident is likely to occur and the risk of the surroundings of the vehicle 1 is high. Therefore, the safety during driving can be improved according to the embodiment.

In addition, in the embodiment, the risk level calculation unit 77 may calculate the risk level based on a shape of a road on which the vehicle 1 is traveling. For example, the risk level calculation unit 77 preferably sets the risk level in a case where the vehicle 1 travels on a curve to be higher than the risk level in a case where the vehicle 1 travels on a straight road.

In addition, the risk level calculation unit 77 preferably sets the risk level in a case where the vehicle 1 is traveling at an intersection to be higher than the risk level in a case where the vehicle 1 is traveling on a road other than the intersection, for example. In addition, the risk level calculation unit 77 preferably sets the risk level in a case where the vehicle 1 is traveling on a downhill road to be higher than the risk level in a case where the vehicle 1 is traveling on an uphill road or a flat road, for example.

As a result, it is possible to prevent the driver D from continuously viewing the HMI 31 to enable the wake word omission function in a case where the risk of the surroundings of the vehicle 1 is high, such as the curve, the intersection, or the downhill road. Therefore, the safety during driving can be improved according to the embodiment.

In addition, in the embodiment, the risk level calculation unit 77 may calculate the risk level based on a type of a road on which the vehicle 1 is traveling. For example, the risk level calculation unit 77 preferably sets the risk level in a case where the vehicle 1 travels on a general road to be higher than the risk level in a case where the vehicle 1 travels on an expressway.

As a result, it is possible to prevent the driver D from continuously viewing the HMI 31 to enable the wake word omission function on a general road where there is a high risk that a pedestrian or the like will jump out from the surroundings as compared with an expressway. Therefore, the safety of the vehicle 1 with respect to the surroundings can be improved according to the embodiment.

In addition, in the embodiment, the risk level calculation unit 77 may calculate the risk level based on a state of other vehicles traveling around the vehicle 1. In this case, for example, the risk level calculation unit 77 preferably calculates the risk level such that a value of the risk level increases as the number of other vehicles traveling around the vehicle 1 increases.

In addition, for example, the risk level calculation unit 77 preferably sets the risk level in a case where there is a vehicle that is dangerously traveling around the vehicle 1 to be higher than the risk level in a case where there is no vehicle that is dangerously traveling around the vehicle 1.

As a result, it is possible to prevent the driver D from continuously viewing the HMI 31 to enable the wake word omission function in a case where the risk of the surroundings of the vehicle 1 is high, such as when there are many surrounding vehicles or there are surrounding vehicles traveling dangerously. Therefore, the safety during driving can be improved according to the embodiment.

In addition, in the embodiment, the risk level calculation unit 77 may calculate the risk level based on a time zone in which the vehicle 1 is traveling. For example, the risk level calculation unit 77 preferably sets the risk level in a case where the vehicle 1 travels in the daytime to be higher than the risk level in the case of traveling night.

In addition, for example, the risk level calculation unit 77 preferably sets the risk level in the case of traveling in an industrial estate on weekdays to be higher than the risk level in the case of traveling in the industrial estate on the weekend. In addition, for example, the risk level calculation unit 77 preferably sets the risk level in the case of traveling around an entertainment facility on the weekend to be higher than the risk level in the case of traveling around the entertainment facility on weekdays.

As a result, it is possible to prevent the driver D from continuously viewing the HMI 31 to enable the wake word omission function in a time zone in which there are many other vehicles, pedestrians, and the like in the surroundings so that the risk of the surroundings of the vehicle 1 is high. Therefore, the safety during driving can be improved according to the embodiment.

In addition, the risk level calculation unit 77 may apply, for example, a “rider state” as an index for the risk level calculation. That is, the risk level calculation unit 77 may detect a rider state of the vehicle 1 and calculate the risk level based on the rider state. Examples of the rider state include a traveling time of a rider, a driving skill of the rider, an accident history of the rider, and an age of the rider.

For example, the risk level calculation unit 77 preferably calculates the risk level such that a value of the risk level increases as the traveling time of the vehicle 1 becomes longer.

As a result, it is possible to suppress the driver D from continuously viewing the HMI 31 to enable the wake word omission function in a case where the driver D has not taken a break for a long time since the start of driving and becomes distracted so that it is difficult to take a sudden response. Therefore, the safety during driving can be improved according to the embodiment.

In addition, for example, the risk level calculation unit 77 preferably sets the risk level in a case where the driving skill of the driver D is poor to be higher than a risk level in a case where the driving skill of the driver D is good. In addition, for example, the risk level calculation unit 77 preferably sets the risk level in a case where the accident history of the driver D is many to be higher than the risk level in a case where the accident history of the driver D is few.

As a result, it is possible to prevent the driver D from continuously viewing the HMI 31 to enable the wake word omission function in a case where the driver D has an inferior driving capability and it is difficult to take a sudden response. Therefore, the safety during driving can be improved according to the embodiment.

In addition, the risk level calculation unit 77 may calculate the risk level based on, for example, an age of the driver D. In this case, for example, the risk level calculation unit 77 may set the risk level in a case where the driver D is a predetermined age or older to be higher than the risk level in a case where the driver D is under the predetermined age. In addition, for example, the risk level calculation unit 77 may set the risk level in a case where the driver D is in the young or the old to be higher than a risk level in the case of being in the middle-aged.

As a result, it is possible to prevent the driver D from continuously viewing the HMI 31 to enable the wake word omission function in a case where the driver D has an inferior driving capability and it is difficult to take a sudden response. Therefore, the safety during driving can be improved according to the embodiment.

In addition, in the embodiment, the risk level calculation unit 77 preferably calculates the risk level of the vehicle 1 and the surroundings of the vehicle 1 by combining various factors described so far.

In addition, in the embodiment, the driver D may be notified that the wake word omission function is disabled due to a high risk in a case where the operation reception unit 76 disables the wake word omission function since the value of the risk level is equal to or higher than the threshold. For example, the operation reception unit 76 may notify the driver D that the wake word omission function is disabled due to a high risk by a display lamp, a message sound, or the like.

As a result, it is possible to prevent the driver D from continuously viewing the HMI 31 to enable the wake word omission function even though the wake word omission function is disabled due to a high risk. Therefore, the safety during driving can be further improved according to the embodiment.

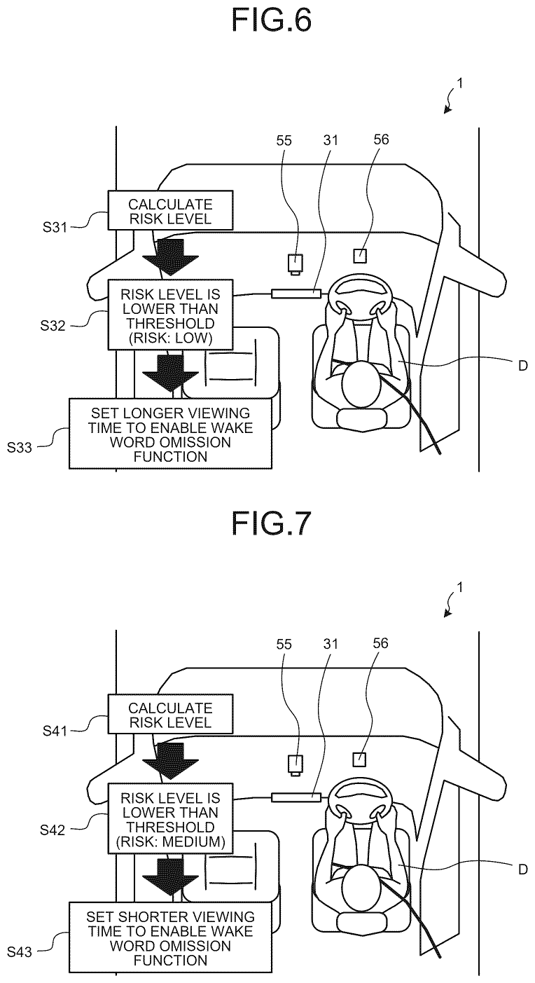

Next, another example of the control processing of the vehicle control system 11 according to the embodiment will be described with reference to FIGS. 6 and 7.

In this example, first, as illustrated in FIG. 6, the risk level calculation unit 77 (see FIG. 3) calculates a risk level of the vehicle 1 itself and a risk level of the surroundings of the vehicle 1 as numerical values (step S31). Since the processing of step S31 is similar to the processing of step S21 described above, a detailed description thereof will be omitted.

Next, the operation reception unit 76 (see FIG. 3) determines whether or not the risk level calculated in the processing of step S31 is equal to or higher than a predetermined threshold. Then, in a case where the risk level is not equal to or higher than the predetermined threshold (that is, is lower than the threshold), the setting unit 78 (see FIG. 3) sets a viewing time required to enable the wake word omission function according to the calculated risk level.

For example, the setting unit 78 increases the viewing time required to enable the wake word omission function as the value of the calculated risk level decreases.

In the example of FIG. 6, the calculated risk level is lower than the predetermined threshold, and the value of the risk level is small (that is, the risk is low) (step S32). Therefore, the setting unit 78 sets a longer viewing time required to enable the wake word omission function (step S33).

In this case, the driver D can operate the on-vehicle device by voice even if the wake word is omitted by continuously viewing the HMI 31 or the like for a time equal to or longer than the set viewing time. On the other hand, even if viewing the HMI 31 or the like for a time shorter than the viewing time, the driver D cannot operate the on-vehicle device by voice without uttering the wake word.

As described above, it is possible to prevent the wake word omission function from malfunctioning by setting the viewing time required to enable the wake word omission function to be long in the example of FIG. 6 in a case where the risk of the vehicle 1 itself and the surroundings of the vehicle 1 is low. Therefore, it is possible to suppress the on-vehicle device from being unintentionally operated by voice according to the embodiment.

In addition, in this another example, as illustrated in FIG. 7, the risk level calculation unit 77 (see FIG. 3) calculates a risk level of the vehicle 1 itself and a risk level of the surroundings of the vehicle 1 as numerical values (step S41). Since the processing of step S41 is similar to the processing of step S21 described above, a detailed description thereof will be omitted.

Next, the operation reception unit 76 determines whether or not the risk level calculated in the processing of step S41 is equal to or higher than a predetermined threshold. Then, in the example of FIG. 7, the calculated risk level is not equal to higher than the predetermined threshold (that is, is lower than the threshold), and a value of the risk level is medium (that is, the risk is medium) (step S42).

Therefore, the setting unit 78 sets the viewing time required to enable the wake word omission function to be shorter than that in the above-described processing of step S33 (step S43).

As described above, in the example of FIG. 7, a time for which the driver D continuously views the HMI 31 can be shortened by setting the viewing time required to enable the wake word omission function is set to be short in a case where the risk level of the vehicle 1 itself and the surroundings of the vehicle 1 is medium. Therefore, the safety during driving can be improved according to the embodiment.

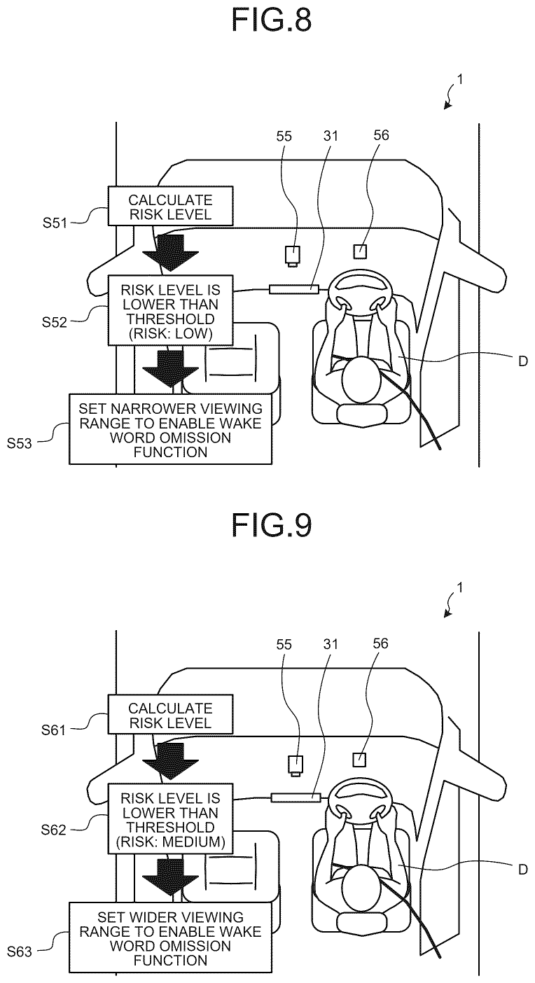

FIGS. 8 and 9 are views for describing examples of processing executed by the vehicle control system 11 according to a modification of the embodiment of the present disclosure.

In this modification, first, as illustrated in FIG. 8, the risk level calculation unit 77 (see FIG. 3) calculates a risk level of the vehicle 1 itself and a risk level of the surroundings of the vehicle 1 as numerical values (step S51). Since the processing of step S51 is similar to the processing of step S21 described above, a detailed description thereof will be omitted.

Next, the operation reception unit 76 (see FIG. 3) determines whether or not the risk level calculated in the processing of step S51 is equal to or higher than a predetermined threshold. Then, in the example of FIG. 8, the calculated risk level is not equal to higher than the predetermined threshold (that is, is lower than the threshold), and a value of the risk level is small (that is, the risk is low) (step S52).

In this case, the setting unit 78 (see FIG. 3) sets a narrower range to be viewed (hereinafter, also referred to as a viewing range) to enable the wake word omission function (step S53). For example, the setting unit 78 limits the range to be viewed to enable the wake word omission function to the HMI 31 itself.

Note that, in this case, the setting unit 78 may set a viewing time required to enable the wake word omission function to be long, similarly to the processing of step S33.

As described above, it is possible to prevent the wake word omission function from malfunctioning by setting the narrower range to be viewed to enable the wake word omission function in the example of FIG. 8 in a case where the risk of the vehicle 1 itself and the surroundings of the vehicle 1 is low. Therefore, it is possible to suppress the on-vehicle device from being unintentionally operated by voice according to the modification.

In addition, in this modification, as illustrated in FIG. 9, the risk level calculation unit 77 (see FIG. 3) calculates a risk level of the vehicle 1 itself and a risk level of the surroundings of the vehicle 1 as numerical values (step S61). Since the processing of step S61 is similar to the processing of step S21 described above, a detailed description thereof will be omitted.

Next, the operation reception unit 76 (see FIG. 3) determines whether or not the risk level calculated in the processing of step S61 is equal to or higher than a predetermined threshold. Then, in the example of FIG. 9, the calculated risk level is not equal to higher than the predetermined threshold (that is, is lower than the threshold), and a value of the risk level is medium (that is, the risk is medium) (step S62).

In this case, the setting unit 78 (see FIG. 3) sets a wider range to be viewed to enable the wake word omission function (step S63). For example, the setting unit 78 widens the range to be viewed to enable the wake word omission function to the HMI 31 and the periphery thereof.

Note that, in this case, the setting unit 78 may set the viewing time required to enable the wake word omission function to be short, similarly to the processing of step S43.

As described above, in the example of FIG. 9, the wake word omission function can be disabled without gazing at the HMI 31 itself by setting the wider range to be viewed to enable the wake word omission function in a case where the risk level of the vehicle 1 itself and the surroundings of the vehicle 1 is medium. Therefore, safety during driving can be improved according to the modification.

Although an example in which the DMS camera 55 is used as the line-of-sight detection unit that detects the direction of the line of sight of the driver D has been described in the embodiment and the modification described above, the present disclosure is not limited to such an example.

For example, an RGB camera provided separately from the DMS camera 55 may be disposed in the vehicle 1, and the direction of the line of sight of the driver D may be detected using the RGB camera.

In addition, an example in which the wake word omission function is enabled in a case where the driver D continuously views a predetermined range (the HMI 31 or the like) has been described in the above-described embodiment and modification, but the term “continuously viewing” in the present disclosure is not limited to a case where the predetermined range is viewed without any break.

For example, in the present disclosure, even when there is an intermittent break in a viewing state, the operation reception unit 76 may determine that “the driver D is in a state of continuously viewing the predetermined range” if the break is instantaneous.

In addition, an example in which the wake word omission function is disabled when the direction of the line of sight of the driver D (that is, the eyeball of the driver D) is directed to the HMI 31 or the like has been described in the above-described embodiment and modification, but the present disclosure is not limited to such an example.

For example, the line-of-sight acquisition unit 74 may capture an image including a three-dimensional shape of a head of the driver D using a separately provided camera adopting an indirect time of flight (iToF) system and acquire a direction in which the head of the driver D is oriented.

Then, the operation reception unit 76 may enable the wake word omission function when the head of the driver D is oriented toward a predetermined range (for example, the HMI 31 or the like) for a certain period of time. Further, the operation reception unit 76 may disable the wake word omission function according to a risk level calculated by the risk level calculation unit 77 as described above. This also makes it possible to improve the safety during driving.

Note that, in a case where the wake word omission function is switched to be enabled or disabled according to the orientation of the head of the driver D, the risk level calculation unit 77 preferably calculates a risk level to be calculated to be higher than that in a case where the wake word omission function is switched to be enabled or disabled according to the orientation of the line of sight of the driver D.

As a result, the safety during driving can also be improved in a case where the entire head is oriented toward the HMI 31 or the like and attention to the front becomes less sufficient.

In addition, a case where the on-vehicle device, that is, a device provided in the vehicle 1 such as a navigation device or an audio device is operated by voice has been described in the above-described embodiment and modification, but the present disclosure is not limited to such an example.

For example, the technology of the present disclosure may be applied to a case where a device (here, a device not connected to the communication network 41 (for example, a mobile device or the like)) in the vehicle is operated by voice in the vehicle 1. This also makes it possible to improve the safety during driving.

Note that, in this case, line-of-sight information and voice information of the driver D, and information for calculating a risk level of the vehicle 1 and the surroundings of the vehicle 1 are preferably acquired using a camera, a microphone, various sensors, and the like provided in the mobile device or the like.

### <Procedure of Control Processing>

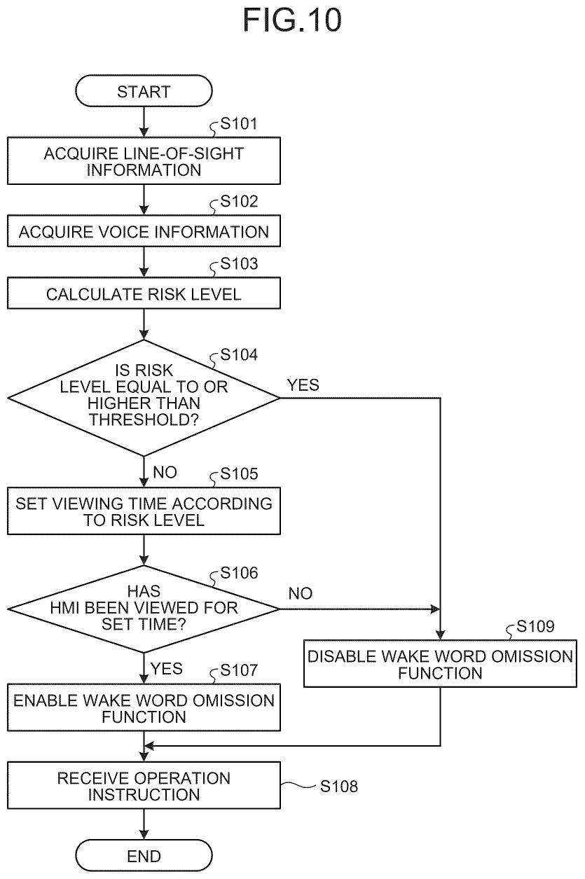

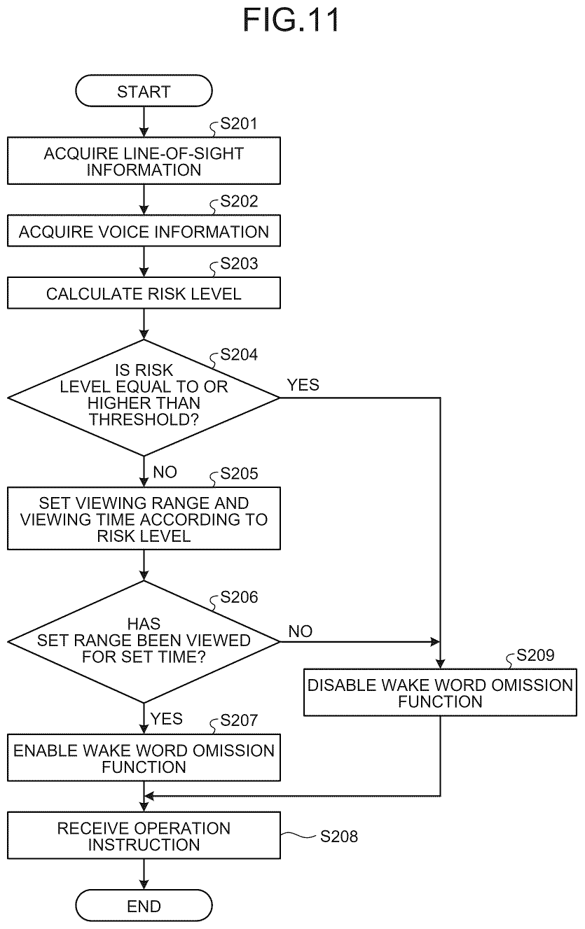

Next, procedure of the control processing according to the embodiment and the modification will be described with reference to FIGS. 10 and 11. FIG. 10 is a flowchart illustrating an example of procedure of the control processing executed by the vehicle control system 11 according to the embodiment of the present disclosure.

First, the travel assistance/autonomous driving control unit 29 acquires line-of-sight information regarding a line of sight of the driver D from the DMS camera 55 (step S101). In addition, the travel assistance/autonomous driving control unit 29 acquires voice information regarding a voice uttered by the driver D from the sound collection unit 56 (step S102).

Note that either the processing of step S101 or the processing of step S102 may be performed first, or both may be performed in parallel.

Next, the travel assistance/autonomous driving control unit 29 calculates a risk level of the vehicle 1 and the surroundings of the vehicle 1 (step S103). For example, the travel assistance/autonomous driving control unit 29 calculates the risk level of the vehicle 1 and the surroundings of the vehicle 1 based on a situation of the vehicle 1 and a situation around the vehicle 1 obtained from the external recognition sensor 25, the in-vehicle sensor 26, the vehicle sensor 27, and the like.

Next, the travel assistance/autonomous driving control unit 29 determines whether or not the risk level calculated in the processing of step S103 is equal to or higher than a predetermined threshold (step S104).

Then, in a case where the risk level is not equal to or higher than the predetermined threshold (step S104, No), the travel assistance/autonomous driving control unit 29 sets the viewing time required to enable the wake word omission function according to the risk level (step S105).

For example, as a value of the risk level decreases, the travel assistance/autonomous driving control unit 29 increases the viewing time for switching the wake word omission function from disabled to enabled.

Next, the travel assistance/autonomous driving control unit 29 determines whether or not the driver D continuously views the HMI 31 for a time set as the viewing time in the processing of step S105 (step S106).

Then, in a case where the driver D continuously views the HMI 31 for the time set as the viewing time (step S106, Yes), the travel assistance/autonomous driving control unit 29 enables the wake word omission function (step S107).

Then, the travel assistance/autonomous driving control unit 29 receives an operation instruction by voice from the driver D (step S108), and ends a series of the control processing.

On the other hand, in a case where the driver D does not continuously view the HMI 31 for the time set as the viewing time (step S106, No), the travel assistance/autonomous driving control unit 29 disables the wake word omission function (step S109). Then, the flow proceeds to the processing of step S108.

In addition, in a case where the risk level is equal to or higher than the predetermined threshold in the processing of step S104 described above (step S104, Yes), the flow proceeds to the processing of step S109.

FIG. 11 is a flowchart illustrating an example of procedure of the control processing executed by the vehicle control system 11 according to the modification of the embodiment of the present disclosure.

First, the travel assistance/autonomous driving control unit 29 acquires line-of-sight information regarding a line of sight of the driver D from the DMS camera 55 (step S201). In addition, the travel assistance/autonomous driving control unit 29 acquires voice information regarding a voice uttered by the driver D from the sound collection unit 56 (step S202).

Note that either the processing of step S201 or the processing of step S202 may be performed first, or both may be performed in parallel.

Next, the travel assistance/autonomous driving control unit 29 calculates a risk level of the vehicle 1 and the surroundings of the vehicle 1 (step S203). Since the processing of step S203 is similar to the processing of step S103 described above, a detailed description thereof will be omitted.

Next, the travel assistance/autonomous driving control unit 29 determines whether or not the risk level calculated in the processing of step S203 is equal to or higher than a predetermined threshold (step S204).

Then, in a case where the risk level is not equal to or higher than the predetermined threshold (step S204, No), the travel assistance/autonomous driving control unit 29 sets a range to be viewed (viewing range) to enable the wake word omission function according to the risk level. Further, the travel assistance/autonomous driving control unit 29 sets a viewing time required to enable the wake word omission function according to the risk level (step S205).

For example, as a value of the risk level decreases, the travel assistance/autonomous driving control unit 29 narrows the viewing range to enable the wake word omission function. In addition, for example, as the value of the risk level decreases, the travel assistance/autonomous driving control unit 29 increases the viewing time for switching the wake word omission function from disabled to enabled.

Next, the travel assistance/autonomous driving control unit 29 determines whether or not the driver D continuously views the range set as the viewing range for a time set as the viewing time in the processing of step S205 (step S206).

Then, in a case where the driver D continuously views the range set as the viewing range for the time set as the viewing time (step S206, Yes), the travel assistance/autonomous driving control unit 29 enables the wake word omission function (step S207).

Then, the travel assistance/autonomous driving control unit 29 receives an operation instruction by voice from the driver D (step S208), and ends a series of the control processing.

On the other hand, in a case where the driver D does not continuously view the range set as the viewing range for the time set as the viewing time (step S206, No), the travel assistance/autonomous driving control unit 29 disables the wake word omission function (step S209). Then, the flow proceeds to step S208.

In addition, in a case where the risk level is equal to or higher than the predetermined threshold in the processing of step S204 described above (step S204, Yes), the flow proceeds to the processing of step S209.

### [Effects]

An information processing apparatus (the travel assistance/autonomous driving control unit 29) according to an embodiment includes the line-of-sight acquisition unit 74, the voice acquisition unit 75, the operation reception unit 76, and the risk level calculation unit 77. The line-of-sight acquisition unit 74 acquires line-of-sight information of the driver D from a line-of-sight detection unit (the DMS camera 55) that detects a line of sight of the driver D. The voice acquisition unit 75 acquires voice information of the driver D from the sound collection unit 56. The operation reception unit 76 receives an operation instruction uttered by the driver D when a predetermined wake word is included in a voice of the driver D. The risk level calculation unit 77 calculates a risk level of the vehicle 1 driven by the driver D and the surroundings of the vehicle 1. In addition, the operation reception unit 76 has a wake word omission function of receiving the operation instruction uttered by the driver D even if the driver D does not include the wake word in the voice of the driver D while the driver D continuously views a predetermined range in the vehicle 1. In addition, the operation reception unit 76 disables the wake word omission function in a case where the risk level calculated by the risk level calculation unit 77 is equal to or higher than a predetermined threshold.

As a result, safety during driving can be improved.

In addition, in the information processing apparatus according to the embodiment, in a case where the risk level calculated by the risk level calculation unit 77 is not equal to or higher than the threshold, the operation reception unit 76 switches the wake word omission function to be enabled or disabled according to a time for which the driver D continuously views the predetermined range.

As a result, the safety during driving can be improved, and it is possible to suppress an on-vehicle device from being unintentionally operated by voice.

In addition, in the information processing apparatus (the travel assistance/autonomous driving control unit 29) according to the embodiment, the operation reception unit 76 increases a viewing time for switching the wake word omission function from disabled to enabled as the risk level calculated by the risk level calculation unit 77 decreases.

As a result, it is possible to suppress the on-vehicle device from being unintentionally operated by voice.

In addition, in the information processing apparatus (the travel assistance/autonomous driving control unit 29) according to the embodiment, the operation reception unit 76 narrows the predetermined range as the risk level calculated by the risk level calculation unit 77 decreases.

As a result, it is possible to suppress the on-vehicle device from being unintentionally operated by voice.

In addition, in the information processing apparatus (the travel assistance/autonomous driving control unit 29) according to the embodiment, the risk level calculation unit 77 increases the risk level as a speed of the vehicle 1 increases.

As a result, the safety during driving can be improved.

In addition, in the information processing apparatus (the travel assistance/autonomous driving control unit 29) according to the embodiment, the risk level calculation unit 77 increases the risk level as a weight of the vehicle 1 increases.

As a result, the safety of the vehicle 1 with respect to the surroundings can be improved.

In addition, in the information processing apparatus (the travel assistance/autonomous driving control unit 29) according to the embodiment, the risk level calculation unit 77 increases the risk level as an accident history at a spot where the vehicle 1 is traveling increases.

As a result, the safety during driving can be improved.

In addition, in the information processing apparatus (the travel assistance/autonomous driving control unit 29) according to the embodiment, the risk level calculation unit 77 sets the risk level in a case where the vehicle 1 travels on a curve to be higher than the risk level in a case where the vehicle 1 travels on a straight road.

As a result, the safety during driving can be improved.

In addition, in the information processing apparatus (the travel assistance/autonomous driving control unit 29) according to the embodiment, the risk level calculation unit 77 sets the risk level in a case where the vehicle 1 travels on a general road to be higher than the risk level in a case where the vehicle 1 travels on an expressway.

As a result, the safety of the vehicle 1 with respect to the surroundings can be improved.

In addition, in the information processing apparatus (the travel assistance/autonomous driving control unit 29) according to the embodiment, the risk level calculation unit 77 sets the risk level in a case where the vehicle 1 travels at an intersection to be higher than the risk level in a case where the vehicle 1 travels on a road other than the intersection.

As a result, the safety during driving can be improved.

In addition, in the information processing apparatus (the travel assistance/autonomous driving control unit 29) according to the embodiment, the risk level calculation unit 77 increases the risk level as the number of other vehicles traveling around the vehicle 1 increases.

As a result, the safety during driving can be improved.

In addition, in the information processing apparatus (the travel assistance/autonomous driving control unit 29) according to the embodiment, the risk level calculation unit 77 sets the risk level in a case where the vehicle 1 travels in the daytime to be higher than the risk level in a case where the vehicle 1 travels at night.

As a result, the safety during driving can be improved.

In addition, in the information processing apparatus (the travel assistance/autonomous driving control unit 29) according to the embodiment, the risk level calculation unit 77 calculates the risk level based on a rider state of the vehicle 1.

As a result, the safety during driving can be improved.

In addition, in the information processing apparatus (the travel assistance/autonomous driving control unit 29) according to the embodiment, the risk level calculation unit 77 increases the risk level as a traveling time of the vehicle 1 becomes longer.

As a result, the safety during driving can be improved.

In addition, in the information processing apparatus (the travel assistance/autonomous driving control unit 29) according to the embodiment, the risk level calculation unit 77 sets the risk level in a case where a driving skill of the driver D is poor to be higher than the risk level in a case where the driving skill of the driver D is good.

As a result, the safety during driving can be improved.

In addition, in the information processing apparatus (the travel assistance/autonomous driving control unit 29) according to the embodiment, the risk level calculation unit 77 sets the risk level in a case where the accident history of the driver D is many to be higher than the risk level in a case where the accident history of the driver D is few.

As a result, the safety during driving can be improved.

In addition, in the information processing apparatus (the travel assistance/autonomous driving control unit 29) according to the embodiment, the risk level calculation unit 77 calculates the risk level based on an age of the driver D.

As a result, the safety during driving can be improved.

In addition, an information processing method according to an embodiment includes a line-of-sight acquisition step (steps S101 and S201), a voice acquisition step (steps S102 and S202), an operation reception step (steps S108 and S208), and a risk level calculation step (steps S103 and S203). The line-of-sight acquisition step (steps S101 and S201) acquires line-of-sight information of the driver D from a line-of-sight detection unit (the DMS camera 55) that detects a line of sight of the driver D. The voice acquisition step (steps S102 and S202) acquires voice information of the driver D from the sound collection unit 56. The operation reception step (steps S108 and S208) receives an operation instruction uttered by the driver D when a predetermined wake word is included in a voice of the driver D. The risk level calculation step (steps S103 and S203) calculates a risk level of the vehicle 1 driven by the driver D and the surroundings of the vehicle 1. In addition, the operation reception step (steps S108 and S208) has a wake word omission function of receiving the operation instruction uttered by the driver D even if the driver D does not include the wake word in the voice of the driver D while the driver D continuously views a predetermined range in the vehicle 1. In addition, the operation reception step (steps S108 and S208) disables the wake word omission function in a case where the risk level calculated in the risk level calculation step (steps S103 and S203) is equal to or higher than a predetermined threshold.

As a result, the safety during driving can be improved.

In addition, the vehicle control system 11 according to the embodiment includes a line-of-sight detection unit (the DMS camera 55), the sound collection unit 56, and a control unit (the travel assistance/autonomous driving control unit 29). The line-of-sight detection unit (the DMS camera 55) is mounted on the vehicle 1 and detects a line of sight of the driver D of the vehicle 1. The sound collection unit 56 is mounted on the vehicle 1. The control unit (the travel assistance/autonomous driving control unit 29) controls the vehicle 1. In addition, the control unit (travel assistance/autonomous driving control unit 29) includes the line-of-sight acquisition unit 74, the voice acquisition unit 75, the operation reception unit 76, and the risk level calculation unit 77. The line-of-sight acquisition unit 74 acquires line-of-sight information of the driver D from a line-of-sight detection unit (the DMS camera 55) that detects a line of sight of the driver D. The voice acquisition unit 75 acquires voice information of the driver D from the sound collection unit 56. The operation reception unit 76 receives an operation instruction uttered by the driver D when a predetermined wake word is included in a voice of the driver D. The risk level calculation unit 77 calculates a risk level of the vehicle 1 driven by the driver D and the surroundings of the vehicle 1. In addition, the operation reception unit 76 has a wake word omission function of receiving the operation instruction uttered by the driver D even if the driver D does not include the wake word in the voice of the driver D while the driver D continuously views a predetermined range in the vehicle 1. In addition, the operation reception unit 76 disables the wake word omission function in a case where the risk level calculated by the risk level calculation unit 77 is equal to or higher than a predetermined threshold.

As a result, the safety during driving can be improved.

Although the above description is given regarding the embodiments of the present disclosure, the technical scope of the present disclosure is not limited to the above-described embodiments as they are, and various modifications can be made without departing from the scope of the present disclosure. In addition, constituent elements in different embodiments and modifications can be combined suitably.

In addition, the effects described in the present specification are merely examples and are not restrictive of the disclosure herein, and other effects not described herein also can be achieved.

Note that the present technology can also have the following configurations.

(1)

An information processing apparatus comprising:
a line-of-sight acquisition unit that acquires line-of-sight information of a driver from a line-of-sight detection unit that detects a line of sight of the driver;
a voice acquisition unit that acquires voice information of the driver from a sound collection unit;
an operation reception unit that receives an operation instruction uttered by the driver when a predetermined wake word is included in a voice of the driver; and
a risk level calculation unit that calculates a risk level of a vehicle driven by the driver and surroundings of the vehicle, wherein
the operation reception unit
has a wake word omission function of receiving an operation instruction uttered by the driver even if the wake word is not included in a voice of the driver while the driver continuously views a predetermined range in the vehicle, and
disables the wake word omission function when the risk level calculated by the risk level calculation unit is equal to or higher than a predetermined threshold.
   (2)

The information processing apparatus according to the above (1), wherein
when the risk level calculated by the risk level calculation unit is not equal to or higher than the threshold, the operation reception unit switches the wake word omission function to be enabled or disabled according to a time for which the driver continuously views the predetermined range.
   (3)

The information processing apparatus according to the above (2), wherein
the operation reception unit increases a viewing time for switching the wake word omission function from disabled to enabled as the risk level calculated by the risk level calculation unit decreases.
   (4)

The information processing apparatus according to any one of the above (1) to (3), wherein
the operation reception unit narrows the predetermined range as the risk level calculated by the risk level calculation unit decreases.
   (5)

The information processing apparatus according to any one of the above (1) to (4), wherein
the risk level calculation unit increases the risk level as a speed of the vehicle increases.
   (6)

The information processing apparatus according to any one of the above (1) to (5), wherein
the risk level calculation unit increases the risk level as a weight of the vehicle increases.
   (7)

The information processing apparatus according to any one of the above (1) to (6), wherein
the risk level calculation unit increases the risk level as an accident history at a spot where the vehicle is traveling increases.
   (8)

The information processing apparatus according to any one of the above (1) to (7), wherein
the risk level calculation unit sets the risk level in a case where the vehicle is traveling on a curve to be higher than the risk level in a case where the vehicle is traveling on a straight road.
   (9) The information processing apparatus according to any one of the above (1) to (8), wherein
the risk level calculation unit sets the risk level in a case where the vehicle is traveling on a general road to be higher than the risk level in a case where the vehicle is traveling on an expressway.
   (10) The information processing apparatus according to any one of the above (1) to (9), wherein
the risk level calculation unit sets the risk level in a case where the vehicle is traveling at an intersection to be higher than the risk level in a case where the vehicle is traveling on a road other than the intersection.
   (11)

The information processing apparatus according to any one of the above (1) to (10), wherein
the risk level calculation unit increases the risk level as a number of other vehicles traveling around the vehicle increases.
   (12)

The information processing apparatus according to any one of the above (1) to (11), wherein
the risk level calculation unit sets the risk level in a case where the vehicle is traveling in daytime to be higher than the risk level in a case where the vehicle is traveling at night.
   (13)

The information processing apparatus according to any one of the above (1) to (12), wherein
the risk level calculation unit calculates the risk level based on a rider state of the vehicle.
   (14)

The information processing apparatus according to the above (13), wherein
the risk level calculation unit increases the risk level as a traveling time of the vehicle increases.
   (15)

The information processing apparatus according to the above (13) or (14), wherein
the risk level calculation unit sets the risk level in a case where a driving skill of the driver is poor to be higher than the risk level in a case where the driving skill of the driver is good.
   (16)

The information processing apparatus according to any one of the above (13) to (15), wherein
the risk level calculation unit sets the risk level in a case where an accident history of the driver is many to be higher than the risk level in a case where the accident history of the driver is few.
   (17)

The information processing apparatus according to any one of the above (13) to (16), wherein
the risk level calculation unit calculates the risk level based on an age of the driver.
   (18)

An information processing method comprising:
a line-of-sight acquisition step of acquiring line-of-sight information of a driver from a line-of-sight detection unit that detects a line of sight of the driver;
a voice acquisition step of acquiring voice information of the driver from a sound collection unit;
an operation reception step of receiving an operation instruction uttered by the driver when a predetermined wake word is included in a voice of the driver; and
a risk level calculation step of calculating a risk level of a vehicle driven by the driver and surroundings of the vehicle, wherein
the operation reception step
has a wake word omission function of receiving an operation instruction uttered by the driver even if the wake word is not included in a voice of the driver while the driver continuously views a predetermined range in the vehicle, and
disables the wake word omission function when the risk level calculated in the risk level calculation step is equal to or higher than a predetermined threshold.
   (19)

The information processing method according to the above (18), wherein
when the risk level calculated in the risk level calculation step is not equal to or higher than the threshold, the operation reception step switches the wake word omission function to be enabled or disabled according to a time for which the driver continuously views the predetermined range.
   (20)

The information processing method according to the above (19), wherein
the operation reception step increases a viewing time for switching the wake word omission function from disabled to enabled as the risk level calculated in the risk level calculation step decreases.
   (21)

The information processing method according to any one of the above (18) to (20), wherein
the operation reception step narrows the predetermined range as the risk level calculated in the risk level calculation step decreases.
   (22)

The information processing method according to any one of the above (18) to (21), wherein
the risk level calculation step increases the risk level as a speed of the vehicle increases.
   (23)

The information processing method according to any one of the above (18) to (22), wherein
the risk level calculation step increases the risk level as a weight of the vehicle increases.
   (24)

The information processing method according to any one of the above (18) to (23), wherein
the risk level calculation step increases the risk level as an accident history at a spot where the vehicle is traveling increases.
   (25)

The information processing method according to any one of the above (18) to (24), wherein
the risk level calculation step sets the risk level in a case where the vehicle is traveling on a curve to be higher than the risk level in a case where the vehicle is traveling on a straight road.
   (26)

The information processing method according to any one of the above (18) to (25), wherein
the risk level calculation step sets the risk level in a case where the vehicle is traveling on a general road to be higher than the risk level in a case where the vehicle is traveling on an expressway.
   (27)

The information processing method according to any one of the above (18) to (26), wherein
the risk level calculation step sets the risk level in a case where the vehicle is traveling at an intersection to be higher than the risk level in a case where the vehicle is traveling on a road other than the intersection.
   (28)

The information processing method according to any one of the above (18) to (27), wherein
the risk level calculation step increases the risk level as the number of other vehicles traveling around the vehicle increases.
   (29)

The information processing method according to any one of the above (18) to (28), wherein
the risk level calculation step sets the risk level in a case where the vehicle is traveling in the daytime to be higher than the risk level in a case where the vehicle is traveling at night.
   (30)

The information processing method according to any one of the above (18) to (29), wherein
the risk level calculation step calculates the risk level based on a rider state of the vehicle.
   (31)

The information processing method according to the above (30), wherein
the risk level calculation step increases the risk level as a traveling time of the vehicle increases.
   (32)

The information processing method according to the above (30) or (31), wherein
the risk level calculation step sets the risk level in a case where a driving skill of the driver is poor to be higher than the risk level in a case where the driving skill of the driver is good.
   (33)

The information processing method according to any one of the above (30) to (32), wherein
the risk level calculation step sets the risk level in a case where an accident history of the driver is many to be higher than the risk level in a case where the accident history of the driver is few.
   (34)

The information processing method according to any one of the above (30) to (33), wherein
the risk level calculation step calculates the risk level based on an age of the driver.
   (35)

A vehicle control system comprising:
a line-of-sight detection unit that is mounted on a vehicle and detects a line of sight of a driver of the vehicle;
a sound collection unit mounted on the vehicle; and
a control unit that controls the vehicle, wherein
the control unit includes:
a line-of-sight acquisition unit that acquires line-of-sight information of the driver from the line-of-sight detection unit;
a voice acquisition unit that acquires voice information of the driver from the sound collection unit;
an operation reception unit that receives an operation instruction uttered by the driver when a predetermined wake word is included in a voice of the driver; and
a risk level calculation unit that calculates a risk level of the vehicle and surroundings of the vehicle, and
the operation reception unit
has a wake word omission function of receiving an operation instruction uttered by the driver even if the wake word is not included in a voice of the driver while the driver continuously views a predetermined range in the vehicle, and
disables the wake word omission function when the risk level calculated by the risk level calculation unit is equal to or higher than a predetermined threshold.
   (36)

The vehicle control system according to the above (35), wherein
when the risk level calculated by the risk level calculation unit is not equal to or higher than the threshold, the operation reception unit switches the wake word omission function to be enabled or disabled according to a time for which the driver continuously views the predetermined range.
   (37)

The vehicle control system according to the above (36), wherein
the operation reception unit increases a viewing time for switching the wake word omission function from disabled to enabled as the risk level calculated by the risk level calculation unit decreases.
   (38)

The vehicle control system according to any one of the above (35) to (37), wherein
the operation reception unit narrows the predetermined range as the risk level calculated by the risk level calculation unit decreases.
   (39)

The vehicle control system according to any one of the above (35) to (38), wherein
the risk level calculation unit increases the risk level as a speed of the vehicle increases
   (40)

The vehicle control system according to any one of the above (35) to (39), wherein
the risk level calculation unit increases the risk level as a weight of the vehicle increases.
   (41)

The vehicle control system according to any one of the above (35) to (40), wherein
the risk level calculation unit increases the risk level as an accident history at a spot where the vehicle is traveling increases.
   (42)

The vehicle control system according to any one of the above (35) to (41), wherein
the risk level calculation unit sets the risk level in a case where the vehicle is traveling on a curve to be higher than the risk level in a case where the vehicle is traveling on a straight road.
   (43)

The vehicle control system according to any one of the above (35) to (42), wherein
the risk level calculation unit sets the risk level in a case where the vehicle is traveling on a general road to be higher than the risk level in a case where the vehicle is traveling on an expressway.
   (44)

The vehicle control system according to any one of the above (35) to (43), wherein
the risk level calculation unit sets the risk level in a case where the vehicle is traveling at an intersection to be higher than the risk level in a case where the vehicle is traveling on a road other than the intersection.
   (45)

The vehicle control system according to any one of the above (35) to (44), wherein
the risk level calculation unit increases the risk level as a number of other vehicles traveling around the vehicle increases.
   (46)

The vehicle control system according to any one of the above (35) to (45), wherein
the risk level calculation unit sets the risk level in a case where the vehicle is traveling in the daytime to be higher than the risk level in a case where the vehicle is traveling at night.
   (47)

The vehicle control system according to any one of the above (35) to (46), wherein
the risk level calculation unit calculates the risk level based on a rider state of the vehicle.
   (48)

The vehicle control system according to the above (47), wherein
the risk level calculation unit increases the risk level as a traveling time of the vehicle increases.
   (49)

The vehicle control system according to the above (47) or (48), wherein
the risk level calculation unit sets the risk level in a case where a driving skill of the driver is poor to be higher than the risk level in a case where the driving skill of the driver is good.
   (50)

The vehicle control system according to any one of the above (47) to (49), wherein
the risk level calculation unit sets the risk level in a case where an accident history of the driver is many to be higher than the risk level in a case where the accident history of the driver is few.
   (51)

The vehicle control system according to any one of the above (47) to (50), wherein
the risk level calculation unit calculates the risk level based on an age of the driver.

### REFERENCE SIGNS LIST

1 VEHICLE
26 IN-VEHICLE SENSOR
29 TRAVEL ASSISTANCE/AUTONOMOUS DRIVING CONTROL UNIT (EXAMPLE OF INFORMATION PROCESSING APPARATUS AND CONTROL UNIT)
55 DMS CAMERA (EXAMPLE OF LINE-OF-SIGHT DETECTION UNIT)
56 SOUND COLLECTION UNIT
61 ANALYSIS UNIT
74 LINE-OF-SIGHT ACQUISITION UNIT
75 VOICE ACQUISITION UNIT
76 OPERATION RECEPTION UNIT
77 RISK LEVEL CALCULATION UNIT
78 SETTING UNIT
D DRIVER

1. An information processing apparatus comprising:
a line-of-sight acquisition unit that acquires line-of-sight information of a driver from a line-of-sight detection unit that detects a line of sight of the driver;
a voice acquisition unit that acquires voice information of the driver from a sound collection unit;
an operation reception unit that receives an operation instruction uttered by the driver when a predetermined wake word is included in a voice of the driver; and
a risk level calculation unit that calculates a risk level of a vehicle driven by the driver and surroundings of the vehicle, wherein
the operation reception unit
has a wake word omission function of receiving an operation instruction uttered by the driver even if the wake word is not included in a voice of the driver while the driver continuously views a predetermined range in the vehicle, and
disables the wake word omission function when the risk level calculated by the risk level calculation unit is equal to or higher than a predetermined threshold.

2. The information processing apparatus according to claim 1, wherein
when the risk level calculated by the risk level calculation unit is not equal to or higher than the threshold, the operation reception unit switches the wake word omission function to be enabled or disabled according to a time for which the driver continuously views the predetermined range.

3. The information processing apparatus according to claim 2, wherein
the operation reception unit increases a viewing time for switching the wake word omission function from disabled to enabled as the risk level calculated by the risk level calculation unit decreases.

4. The information processing apparatus according to claim 1, wherein
the operation reception unit narrows the predetermined range as the risk level calculated by the risk level calculation unit decreases.

5. The information processing apparatus according to claim 1, wherein
the risk level calculation unit increases the risk level as a speed of the vehicle increases.

6. The information processing apparatus according to claim 1, wherein
the risk level calculation unit increases the risk level as a weight of the vehicle increases.

7. The information processing apparatus according to claim 1, wherein
the risk level calculation unit increases the risk level as an accident history at a spot where the vehicle is traveling increases.

8. The information processing apparatus according to claim 1, wherein
the risk level calculation unit sets the risk level in a case where the vehicle is traveling on a curve to be higher than the risk level in a case where the vehicle is traveling on a straight road.

9. The information processing apparatus according to claim 1, wherein
the risk level calculation unit sets the risk level in a case where the vehicle is traveling on a general road to be higher than the risk level in a case where the vehicle is traveling on an expressway.

10. The information processing apparatus according to claim 1, wherein
the risk level calculation unit sets the risk level in a case where the vehicle is traveling at an intersection to be higher than the risk level in a case where the vehicle is traveling on a road other than the intersection.

11. The information processing apparatus according to claim 1, wherein
the risk level calculation unit increases the risk level as a number of other vehicles traveling around the vehicle increases.

12. The information processing apparatus according to claim 1, wherein
the risk level calculation unit sets the risk level in a case where the vehicle is traveling in daytime to be higher than the risk level in a case where the vehicle is traveling at night.

13. The information processing apparatus according to claim 1, wherein
the risk level calculation unit calculates the risk level based on a rider state of the vehicle.

14. The information processing apparatus according to claim 13, wherein
the risk level calculation unit increases the risk level as a traveling time of the vehicle increases.

15. The information processing apparatus according to claim 13, wherein
the risk level calculation unit sets the risk level in a case where a driving skill of the driver is poor to be higher than the risk level in a case where the driving skill of the driver is good.

16. The information processing apparatus according to claim 13, wherein
the risk level calculation unit sets the risk level in a case where an accident history of the driver is many to be higher than the risk level in a case where the accident history of the driver is few.

17. The information processing apparatus according to claim 13, wherein
the risk level calculation unit calculates the risk level based on an age of the driver.

18. An information processing method comprising:
a line-of-sight acquisition step of acquiring line-of-sight information of a driver from a line-of-sight detection unit that detects a line of sight of the driver;
a voice acquisition step of acquiring voice information of the driver from a sound collection unit;
an operation reception step of receiving an operation instruction uttered by the driver when a predetermined wake word is included in a voice of the driver; and
a risk level calculation step of calculating a risk level of a vehicle driven by the driver and surroundings of the vehicle, wherein
the operation reception step
has a wake word omission function of receiving an operation instruction uttered by the driver even if the wake word is not included in a voice of the driver while the driver continuously views a predetermined range in the vehicle, and
disables the wake word omission function when the risk level calculated in the risk level calculation step is equal to or higher than a predetermined threshold.

19. A vehicle control system comprising:
a line-of-sight detection unit that is mounted on a vehicle and detects a line of sight of a driver of the vehicle;
a sound collection unit mounted on the vehicle; and
a control unit that controls the vehicle, wherein
the control unit includes:
a line-of-sight acquisition unit that acquires line-of-sight information of the driver from the line-of-sight detection unit;
a voice acquisition unit that acquires voice information of the driver from the sound collection unit;
an operation reception unit that receives an operation instruction uttered by the driver when a predetermined wake word is included in a voice of the driver; and
a risk level calculation unit that calculates a risk level of the vehicle and surroundings of the vehicle, and
the operation reception unit
has a wake word omission function of receiving an operation instruction uttered by the driver even if the wake word is not included in a voice of the driver while the driver continuously views a predetermined range in the vehicle, and
disables the wake word omission function when the risk level calculated by the risk level calculation unit is equal to or higher than a predetermined threshold.
